(19) United States
(12) Patent Application Publication
(10) Pub. No.: US 2023/0156138 A1
(43) Pub. Date: May 18, 2023

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: Masaya Soga, Kanagawa (JP)

(21) Appl. No.: 17/981,307

(22) Filed: Nov. 4, 2022

(30) Foreign Application Priority Data
Nov. 15, 2021 (JP) 2021-185482

(51) Int. Cl. H04N 1/40; H04N 1/32; H04N 1/00

(52) U.S. Cl. CPC H04N 1/40; H04N 1/32128; H04N 1/00209

(57) ABSTRACT

According to an aspect of the present disclosure, an information processing apparatus comprises one or more memories, and one or more processors in communication with the one or more memories, wherein the one or more processors are configured to generate data including information of one or more character strings recognized from a scanned document image, wherein the one or more character strings correspond respectively to one or more character areas detected from the scanned document image, generate a preview image with a character decoration to the one or more character areas of the scanned document image; and transmit the preview image, the data, and the file including the scanned document image together, wherein a same character decoration as each of the one or more character areas on the preview image is applied for a different one of the one or more character strings included in the data.

### BACKGROUND

### Field of the Disclosure

The present disclosure relates to an information processing apparatus that automatically assigns file names to images of scanned documents, a method of controlling the information processing apparatus, and a storage medium.

### Description of the Related Art

Conventionally, there is a system that manages sheet forms by scanning the sheet forms into electronic data files (electronic forms) and setting file names of the electronic data files based on contents of the sheet forms. To set a file name, there is a method to set the file name based on a recognition result of performing character recognition processing on a form image. Also, if a user scans a form with a format similar to the learned form by learning in advance the character area of the form used for the file name, there is a method to automatically determine the character string to be used for the file name based on a result of the learning.

In a file naming screen in which the user determines, from character areas recognized on a form image, a character area to be used for the file name, there is a method of performing, on the form image, a coloring or shading process for a character area used for the file name. The position of the character area used as the file name can be easily confirmed by the above method. There is also a method to automatically name the scanned form based on a result of the learning process, skip the file naming screen, and automatically transmit the named and scanned form to a form management system. In this case, it is necessary to confirm whether or not the file name that is automatically set is appropriate in the form management system to which the file is transmitted, by confirming a preview image on the form management system that manages the set file name and the form, and the like.

Japanese Patent Application Laid-Open No. 2017-184047 discloses a method to generate a preview image in a document management system so that the contents of the document can be easily confirmed according to the contents of the managed document.

However, according to the method of Japanese Patent Application Laid-Open No. 2017-184047, it cannot be easily confirmed which character area of the form is used because the user cannot generate a preview image of the form based on information of the character area used for naming the file name.

In view of the above problems, the present disclosure provides a system in which the character area of a character string used for giving a file name to an image of a scanned document can be easily confirmed from a preview image.

### SUMMARY

According to an aspect of the present disclosure, an information processing apparatus comprises one or more memories, and one or more processors in communication with the one or more memories, wherein the one or more processors are configured to generate data including information of one or more character strings recognized from a scanned document image, wherein the one or more character strings correspond respectively to one or more character areas detected from the scanned document image; generate a preview image with a character decoration to the one or more character areas of the scanned document image; and transmit the preview image, the data, and the file including the scanned document image together, wherein a same character decoration as each of the one or more character areas on the preview image is applied for a different one of the one or more character strings included in the data.

Further features of the present disclosure will become apparent from the following description of exemplary embodiments with reference to the attached drawings.

### BRIEF DESCRIPTION OF THE DRAWINGS

FIG. 1 illustrates an overall configuration of a system of the present embodiment.

FIG. 2 illustrates a hardware configuration of the MFP.

FIG. 3 illustrates a hardware configuration of a client PC and MFP cooperation services.

FIG. 4 illustrates a software configuration diagram of the system of the present embodiment.

FIG. 5 illustrates a sequence diagram showing the flow of processing between each apparatus.

FIG. 6A illustrates an example of a screen displayed by the MFP or the client PC.

FIG. 6B illustrates an example of a screen displayed by the MFP or the client PC.

FIG. 7 illustrates a flowchart showing details of image analysis processing performed by the image processing unit.

FIG. 8A illustrates an example of the outline of the data structure to be saved in the analysis result saving process performed by the image processing unit.

FIG. 8B illustrates an example of the details of the data structure to be saved in the analysis result saving process performed by the image processing unit.

FIG. 9 illustrates an example of the screen of the automatic transmission setting.

FIG. 10 illustrates a flowchart showing the details of the automatic transmission process.

FIG. 11 illustrates an example of the screen of the automatic transmission result.

### DESCRIPTION OF THE EMBODIMENTS

Hereafter, the configuration for carrying out the present disclosure is described using drawings. It should be noted that the following embodiment does not limit the disclosure claimed, and not all combinations of features described in the embodiment are essential to the means of solving the disclosure.

### First Embodiment

(Overall Configuration)

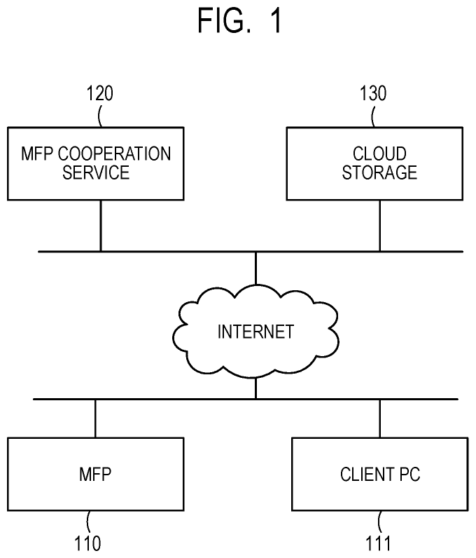

FIG. 1 illustrates the overall configuration of this system. An image processing system includes a MFP (Multifunction Peripheral) 110, a client PC 111, a MFP cooperation service 120, and a cloud storage 130. The MFP 110 and the client PC 111 are communicably connected via a LAN (Local Area Network) to a server providing various services on the internet.

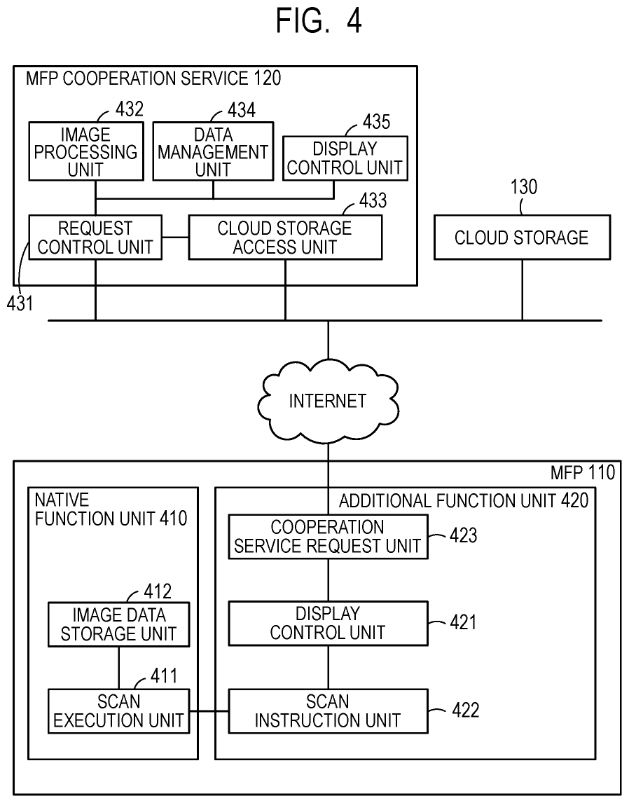

The MFP 110 is a multifunction peripheral with multiple functions such as a scanner and a printer and is an example of an image processing apparatus. The client PC 111 is a computer that receives services from the MFP cooperation service 120. In the present embodiment, an application corresponding to an additional function unit 420 (described later with reference to FIG. 4) that is installed in the MFP 110 may be installed and executed in the client PC 111 to execute the processing performed by the MFP 110 in the client PC 111. The MFP cooperation service 120 is an example of a service that stores a document image file scanned by the MFP 110 on a server of the MFP cooperation service 120 and transfers the document image file to a service that can store files, such as other storage services. The MFP cooperation service 120 is implemented and executed by the information processing apparatus. The cloud storage 130 may be a storage apparatus and a service that can store files via the internet. The files stored in the cloud storage 130 can be obtained via a web browser on the MFP 110 or the client PC 111.

The image processing system of the present embodiment includes the MFP 110 as an image processing apparatus, the client PC 111, the MFP cooperation service 120, and the cloud storage 130 as a storage apparatus, but is not limited to the above configuration. For example, the MFP 110 may also work as the client PC 111 and the MFP cooperation service 120. In addition, the information processing apparatus providing the MFP cooperation service 120 may be a server on the LAN rather than on the internet. Further, the cloud storage 130, which is a storage apparatus, may be replaced with a mail server, and the like, and scanned images may be attached to an email and transmitted.

(Hardware Configuration of the MFP)

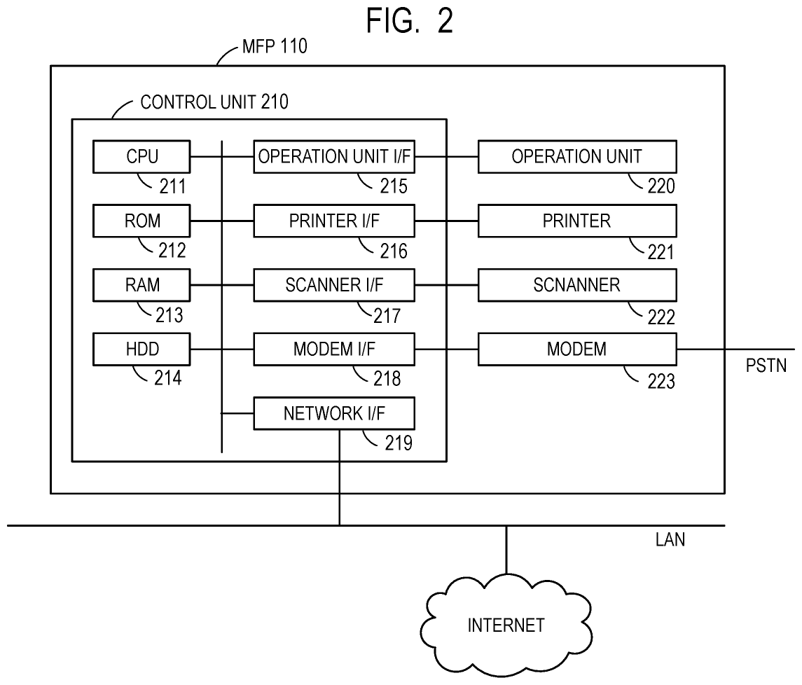

FIG. 2 illustrates a hardware configuration of the MFP 110, which is an image processing apparatus. The MFP 110 includes a control unit 210, an operation unit 220, a printer 221, a scanner 222, and a modem 223. The control unit 210 controls the operation of the entire MFP 110 and includes a CPU 211, a ROM 212, a RAM 213, an HDD 214, an operation unit I/F 215, a printer I/F 216, a scanner I/F 217, a modem I/F 218, and a network I/F 219. The CPU 211 reads a control program stored in the ROM 212 to execute and control various functions of the MFP 110 such as scanning, printing, and communications and the like. The RAM 213 is used as a temporary storage area such as a main memory and a work area of the CPU 211. In the present embodiment, one CPU 211 uses one memory (the RAM 213 or the HDD 214) to perform each of the processes described in the flowchart shown below, but the present embodiment is not limited to the above configuration. For example, multiple CPUs or multiple RAMs or HDDs may cooperate to execute each process. The HDD 214 is a mass storage unit that stores image data and various programs.

The operation unit I/F 215 is an interface connecting the operation unit 220 and the control unit 210. The operation unit 220 includes a touch panel, a keyboard, and the like to receive operations, inputs, and instructions from a user. The printer I/F 216 is an interface connecting the printer 221 and the control unit 210. The image data for printing is transferred from the control unit 210 to the printer 221 via the printer I/F 216 and printed on a sheet or the like. The scanner I/F 217 is an interface connecting the scanner 222 and the control unit 210. The scanner 222 scans a document set on a document stage or in an ADF (Auto Document Feeder) (not shown in FIG. 2) to generate image data, and inputs the image data to the control unit 210 via the scanner I/F 217. The MFP 110 can print out (copy) the image data generated by the scanner 222 via the printer 221, and can also transmit files and emails. The modem I/F 218 is an interface connecting the modem 223 and the control unit 210. The modem 223 performs facsimile communications of image data with a facsimile machine on a PSTN (Public Switched Telephone Network). The network I/F 219 is an interface that connects the control unit 210 (MFP 110) to the LAN. The MFP 110 uses the network I/F 219 to transmit image data and information to each service on the internet and to receive various kinds of information.

(Hardware Configuration of the Client PC and the MFP Cooperation Service)

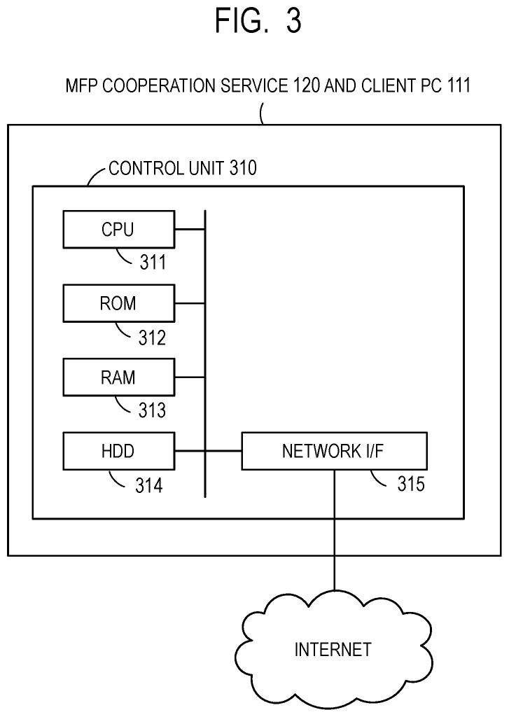

FIG. 3 illustrates a hardware configuration diagram of an information processing apparatus providing the client PC 111 and the MFP cooperation service 120. The client PC 111 and the MFP cooperation service 120 include a CPU 311, a ROM 312, a RAM 313, an HDD 314 and a network I/F 315. The CPU 311 controls the entire operation by reading a control program stored in the ROM 312 and executing various processes. The RAM 313 is used as a temporary storage area such as the main memory and a work area of the CPU 311. The HDD 314 is a mass storage unit that stores image data and various programs. The network I/F 315 is an interface for connecting the MFP cooperation service 120 to the internet. The MFP cooperation service 120 and the cloud storage 130 receive processing requests from other apparatuses (such as the MFP 110) via the network I/F 315 and transmit and receive various information.

(Software Configuration of the Image Processing System)

<The MFP>

FIG. 4 illustrates a software configuration diagram of the image processing system according to the present embodiment. The MFP 110 includes two units: a native function unit 410 and the additional function unit 420. Each unit included in the native function unit 410 is standard for the MFP 110, while the additional function unit 420 is an application additionally installed in the MFP 110. The additional function unit 420 is a Java®-based application used to easily add functions to the MFP 110. Other additional applications not shown may be installed in the MFP 110.

The native function unit 410 includes a scan execution unit 411 and an image data storage unit 412. The additional function unit 420 includes a display control unit 421, a scan instruction unit 422, and a cooperation service request unit 423.

The display control unit 421 displays a UI screen for receiving an operation from the user on a liquid crystal display unit having a touch panel function included in the operation unit 220 of the MFP 110. For example, the display control unit 421 displays the UI screen such as inputting authentication information to access the MFP cooperation service 120, scan settings, scan start operations, and preview screens. The scan instruction unit 422 requests scan processing to the scan execution unit 411 together with scan settings according to the user instructions input via the UI screen.

The scan execution unit 411 receives a scan request including scan settings from the scan instruction unit 422. The scan execution unit 411 generates scan image data by scanning the original document placed on the stage glass using the scanner 222 according to the scan request. The generated scanned document image data is transmitted to the image data storage unit 412. The scan execution unit 411 transmits a scan image identifier that uniquely indicates the stored scan document image data to the scan instruction unit 422. The scan image identifier is a number, symbol, alphabet, and the like (not shown) for uniquely identifying the image scanned in the MFP 110. The image data storage unit 412 stores the scanned image data received from the scan execution unit 411 in the HDD 214.

The scan instruction unit 422 obtains, from the image data storage unit 412, the scan document image data corresponding to the scan image identifier received from the scan execution unit 411. The scan instruction unit 422 requests an instruction to perform processing on the obtained scanned document image data by the MFP cooperation service 120 to the cooperation service request unit 423.

The cooperation service request unit 423 requests various processing to the MFP cooperation service 120. For example, the cooperation service request unit 423 makes requests to log in, to analyze a scanned image, or to transmit a scanned image. The interactions with the MFP cooperation service 120 are performed by using protocols such as REST and SOAP, but other means of communications may be used.

<The MFP Cooperation Service>

The MFP cooperation service 120 includes a request control unit 431, an image processing unit 432, a cloud storage access unit 433, a data management unit 434, and a display control unit 435.

The request control unit 431 waits in a state in which the request control unit 431 can receive a processing request from an external apparatus. If the processing request is received, processing is instructed to the image processing unit 432, the cloud storage access unit 433, and the data management unit 434 as appropriate according to the processing request.

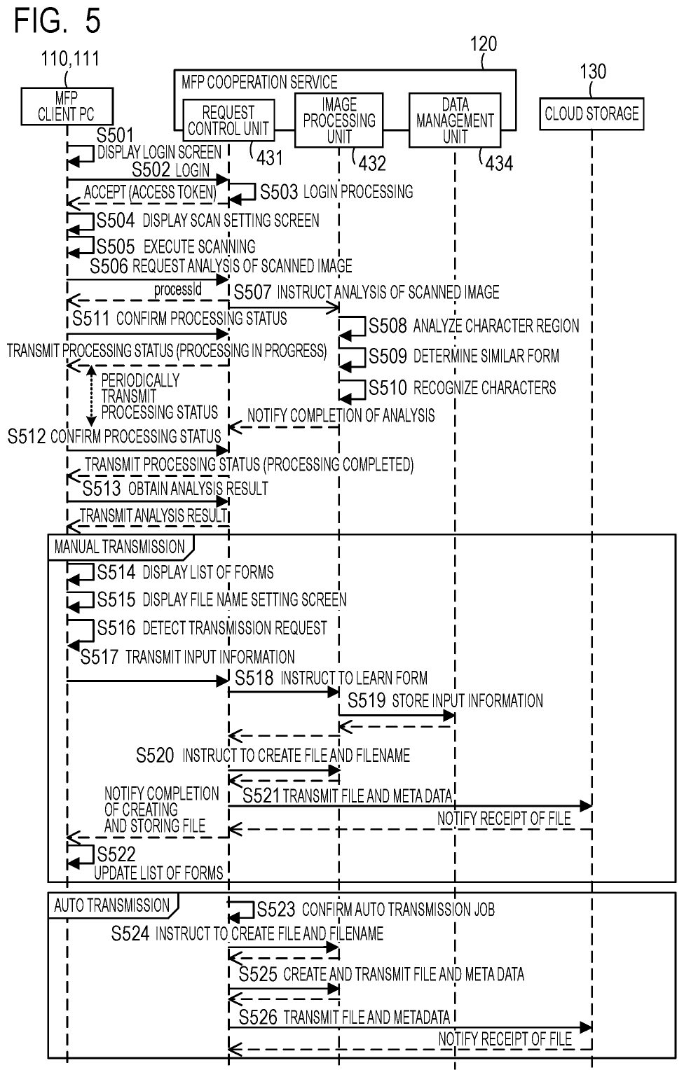

The image processing unit 432 performs character area analysis, OCR (Optical Character Recognition), similar form determination (to be described later in the process of step S510 in FIG. 5), image recognition processing such as image rotation and tilt correction, and image processing on the image.

The cloud storage access unit 433 makes a processing request to the cloud storage 130. Cloud services may typically use protocols such as REST and SOAP, and release and provide various interfaces for storing and obtaining files stored in the cloud storage 130. The cloud storage access unit 433 performs the operation of the cloud storage 130 using the released and provided interfaces of the cloud storage 130.

The data management unit 434 holds user information, various setting data, and the like managed by the MFP cooperation service 120.

In response to a request from a web browser operating on other terminals (not shown) such as a PC or a mobile terminal connected via the internet, the display control unit 435 returns screen configuration information (HTML, CSS, etc.) necessary for displaying the screen. The user can view user information registered in the MFP cooperation service 120 via the screen displayed in the web browser and can change scan settings.

Although FIG. 4 describes an example of a configuration in which the additional function unit 420 is installed in the MFP 110, the present embodiment is not limited to the above configuration, and the client PC 111 may include the function of the additional function unit 420.

(Overall Processing Flow)

FIG. 5 illustrates a sequence diagram showing the flow of processing between apparatuses when the image scanned by the MFP 110 is digitized as a file and transmitted to the cloud storage 130. Here, the interaction between the apparatuses will be discussed. Although FIG. 5 describes that the MFP 110 interacts with the MFP cooperation service 120, obtaining the analysis result, the display of the screen, the instruction of learning, and the like described later may be performed by the client PC 111 instead of the MFP 110. Hereafter, for the processing executed by the “MFP 110 or client PC 111”, only the “MFP 110” is described by omitting the description of the client PC 111.

The MFP 110 displays a main screen on the touch panel with buttons for executing each function under normal conditions.

If an additional application (hereinafter referred to as “scan application”) to transmit scanned forms to the cloud storage 130 is installed on the MFP 110, a button to launch the application's functions appears on the main screen of the MFP 110. If this button is pressed, a screen for transmitting the scanned forms to the cloud storage 130 is displayed and the processing shown in the sequence of FIG. 5 is performed.

In step S501, the MFP 110 displays a login screen for inputting authentication information for accessing the MFP cooperation service 120. Then, in step S502, the user performs a login operation, and the MFP 110 transmits a user name, a password, and the like to the MFP cooperation service 120.

In step S503, the MFP cooperation service 120 verifies that the user name and password included in the login request are correct. If the user name and password are correct, the MFP cooperation service 120 returns the access token to the MFP 110. The various requests from the MFP 110 to the MFP cooperation service 120 thereafter are transmitted together with this access token, and the user requesting the process can be identified by this information. The method of user authentication is generally performed using well-known techniques (Basic authentication, Digest authentication, authorization using OAuth, and the like).

If the login processing is completed, the MFP 110 displays a scan setting screen in step S504. The user makes settings for scanning a form, places a form sheet to be scanned on the stage glass or ADF, and presses a button for starting the scanning. In step S505, the MFP 110 scans the form sheet to generate image data that digitizes the form sheet. Then, in step S506, the MFP 110 transmits an analysis request of the scanned image data to the MFP cooperation service 120 along with the image data generated by the scanning processing. At this time, all scanned document images may be transmitted, or only the target to be analyzed may be transmitted first and all scanned document images may be transmitted later.

Upon receiving the analysis request of the scanned image data, the MFP cooperation service 120 starts image analysis in the image processing unit 432 of the MFP cooperation service 120 in step S507. Then, without waiting for the completion of the image analysis processing, the MFP cooperation service 120 returns “processId” to the MFP 110.

After receiving the request, the MFP cooperation service 120 performs image analysis processing by using the image processing unit 432. First, in step S508, the image analysis processing is executed to analyze a character area existing in the image. Then, in step S509, the arrangement information of the character area in the form is used to compare the arrangement information of the image data scanned in the past with the arrangement information of the image data scanned this time. This process is called the “similar form determination”. The information of document image scanned in the past used in the determination is stored and accumulated by the processing of step S519 described later. This process is called “form learning”.

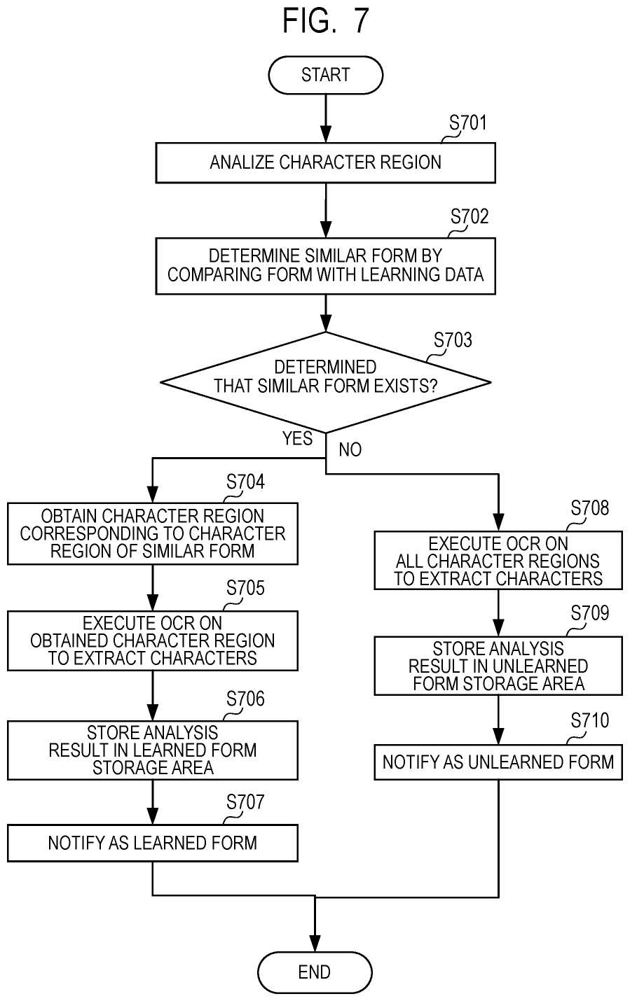

In step S510, character recognition processing is performed on the analyzed character area based on the determination result in step S509. Details of the processing in steps S508 to S510 will be described later with reference to FIG. 7.

In step S511, the MFP 110 uses the “processId” received in the response in step S506 to periodically (for example, every several hundred to several milliseconds or so) confirm the processing status of the image analysis indicated by the “processId” with the MFP cooperation service 120. Although omitted in the figure, the processing in step S511 is continued until a response of image processing completion by the MFP cooperation service 120 can be obtained (until the timing in step S512).

In step S512, if the MFP cooperation service 120 receives a request to confirm the processing status, the MFP cooperation service 120 confirms the processing status indicated by “processId” and returns a response. The response includes a string indicating the current processing status in a variable of “status”. For example, if the variable of “status” includes “processing”, the response indicates that the processing is performed by the MFP cooperation service 120. If the variable of “status” includes “completed”, the response indicates that the processing is completed. It should be noted that the MFP cooperation service 120 may return other statuses of the variable such as “failed” if the processing fails. The response at the completion of processing (if the variable of “status” includes “completed”) includes information such as a result of analyzing the scanned image data and scan settings along with the status.

In steps S504 to S513, the process is repeated for as many forms as the user scans. Alternatively, a plurality of forms may be scanned in step S505, the plurality of forms may be divided into sets of a predetermined number of forms in step S507, the predetermined number of forms may be performed by the images processing, and the processing of steps S506 to S513 may be repeated for the number of sets of divided forms. If the completion of processing is detected in step S512, the result information is obtained from a URL where the result information included in the response is stored in step S513.

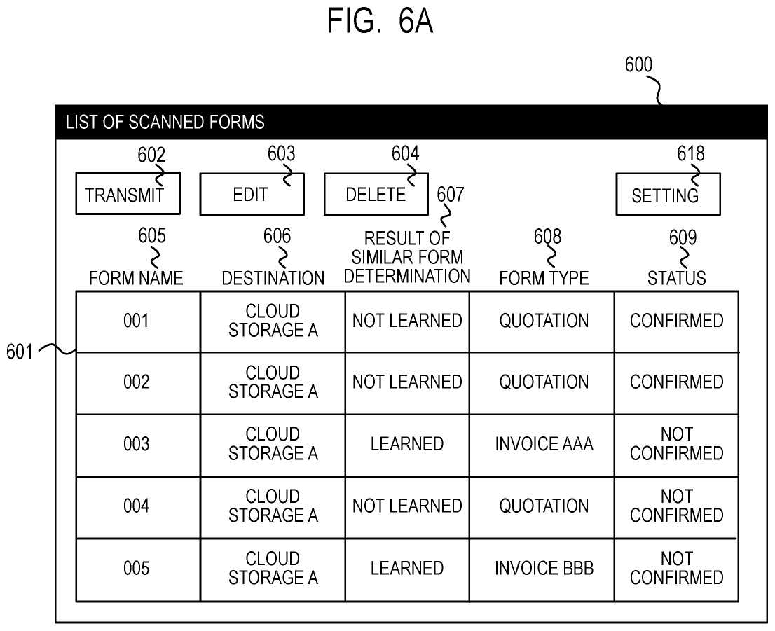

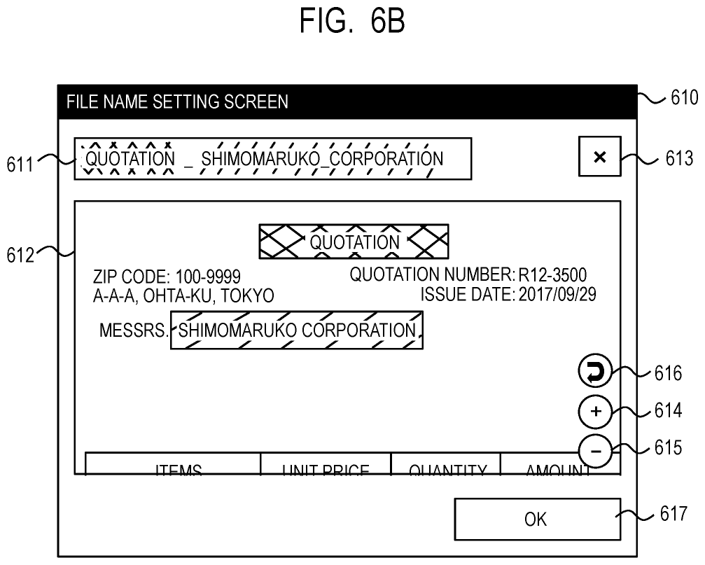

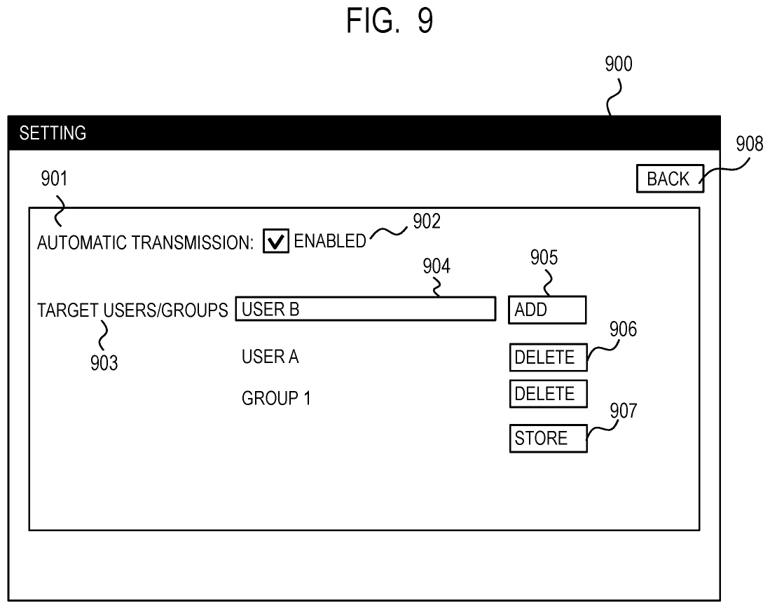

If an automatic transmission setting is not enabled in the setting screen 900, the process in steps S514 to S522 is performed for all forms scanned in steps S504 to S513. On the other hand, if the automatic transmission setting is enabled, the process in steps S514 to S522 is performed for the form determined to be an unlearned form in step S509 and the process in steps S523 to S526 is performed for the form determined to be learned form in step S509. In the present embodiment, transmitting forms to the cloud storage 130 by the process in steps S514 to S522 is called a “manual transmission”. The transmitting forms to cloud storage 130 by the process steps S523 to S526 is called an “automatic transmission”. The automatic or manual transmission setting will be described later with reference to FIG. 9. The form determined to be a learned form in step S509 may always be automatically transmitted without an option for the automatic transmission setting in the setting screen 900. Further, even learned forms may be automatically transmitted depending on the degree of certainty of character recognition and form recognition (certainty of recognition accuracy). If the process is performed by the manual transmission, in step S514, the form list shown in FIG. 6A is displayed using the result information obtained in step S513. The user manually operates the displayed screen of the form list to transmit the form. If the process is performed by the automatic transmission, steps S523 to S526 are performed automatically.

FIG. 6A illustrates an example of the scanned form list screen 600 displayed by the MFP 110. In the example of FIG. 6A, the automatic transmission setting is disabled and both unlearned and learned forms are listed. Further, by selecting and double-clicking any one of the forms in the form list shown in FIG. 6A, the file name setting screen as shown in FIG. 6B for setting a file name in step S515 is displayed. Details of the processing in the file name setting screen will be described later.

The user sets a file name in the scanning form on the file name setting screen and presses a transmit button 602. Then, in step S516, the MFP 110 detects a transmission request. The MFP 110 transmits information of the character area used to set the file name as input information and the input string information to the MFP cooperation service 120 in the subsequent step S517. Upon receiving the request for learning in step S518, the request control unit 431 of the MFP cooperation service 120 requests the image processing unit 432 to learn the form. In step S519, the image processing unit 432 stores information of the character area of the entire image and the input information of the character area received in step S518, which is used for the file name by the user.

Then, in step S520, the MFP cooperation service 120 obtains information of a file format that is to be transmitted to the cloud storage 130 from the scan settings registered in the MFP cooperation service 120, and generates a file from the scanned document image based on the settings. Further, metadata information such as the file name to be set in the file of the scanned image is generated. In step S521, the MFP cooperation service 120 transmits files and metadata to the cloud storage 130. Upon receiving the response of the transmission of the input information, the MFP 110 terminates the processing and updates the form list based on the result of re-determination in step S522.

In step S523, it is confirmed whether there is a job performed by the automatic transmission. If there is a job performed by the automatic transmission, the process proceeds to step S524.

In step S524, the MFP cooperation service 120 obtains information of the file format to be transmitted to the cloud storage 130 from the scan settings registered in the MFP cooperation service 120 and generates a file from the scanned image based on the settings. Further, the MFP cooperation service 120 generates metadata information such as the file name to be set in the file of the scanned image. Then, in step S525, preview images and metadata are generated based on the learning results to be transmitted at the time of performing the automatic transmission. Details will be described later. In step S526, the generated files and metadata are transmitted to the cloud storage 130. The processing of the automatic transmissions may be performed in parallel with the processing of the manual transmissions or after the completion of the manual transmissions.

<Screen of the MFP>

FIGS. 6A and 6B illustrate examples of the screens displayed by the MFP 110. FIG. 6A illustrates an example of the scanned form list screen 600. On the screen, the user can view a list of forms after completing the scanning and the image analysis but before the transmission to the cloud storage 130. The screen also includes a scanned form list 601, the transmit button 602, an edit button 603, a delete button 604 and a setting button 618. The scanned form list 601 is a list of forms for which the scanning and the image analysis (steps S505 to S510) have been completed.

The scanned form list 601 has a form name 605, a destination 606, a result of similar form determination 607, a form type 608, and a confirmation status 609. The form name 605 is an identifier that uniquely identifies the name of the form. The destination 606 is a name of the cloud storage 130 to which the form file is to be transmitted. The result of similar form determination 607 indicates a result for performing the similar form determination on the form. The result of similar form determination 607 indicates either “unlearned” or “learned”. The determination result of “unlearned” means that there is no similar form, and the determination result of “learned” means that there is a similar form. The form type 608 indicates the type of the form. For example, “quotation” or “invoice” is displayed. For the “learned” forms determined based on the result of the similar form determination 607, detailed types such as “invoice AAA” or “invoice BBB” are displayed to indicate the correspondences of invoice formats. The form type 608 is associated with the most similar form determined by the similar form determination process. The confirmation status 609 indicates whether the user has confirmed the form or not and displays a status as “confirmed” or “unconfirmed”. If the edit button 603 is pressed with one form selected from the scanned form list 601 and a file name setting screen 610 corresponding to the form is displayed, the confirmation status 609 displays the status as “confirmed” in the field corresponding to the form on subsequent screens 600. The status “confirmed” or “unconfirmed” may be displayed as an icon indicating a state rather than a letter as shown in FIG. 6A, or as a background color applied to each row.

The transmit button 602 is a button for transmitting a form to the cloud storage 130. A form is selected from the list of scanned forms 601 and transmitted to the cloud storage 130 displayed in the destination 606 by pressing the transmit button 602. If the transmission is successful, the form is removed from the list.

The edit button 603 is a button for moving the screen to the file name setting screen 610 (FIG. 6B) described later. A form is selected from the scanned form list 601 and the screen is moved to the file name setting screen 610 of the selected form by pressing the edit button 603.

The delete button 604 is a button for deleting the form. Any form can be selected from the scanned form list 601, and the selected form can be deleted by pressing the delete button 604.

If the setting button 618 is pressed, the setting screen 900 of FIG. 9 is displayed to enable the automatic transmission. If the automatic transmission is enabled, the user can set which user group is enabled. Details will be described.

FIG. 6B illustrates an example of a file name setting screen 610. A file name area 611 displays a file name set by the user. An on-screen keyboard allowing the user to input any characters is displayed by touching a blank area in the file name area 611. If the file name has been set and strings have been displayed, the on-screen keyboard is displayed and the user can correct the strings of the touched area by touching the strings.

A preview area 612 displays an image of the scanned document. The user can add strings included in the character area corresponding to the touched position as a file name by touching the character area of the image. The selected character string may be displayed by adding a shape such as a line, a border, and the like, or a color to the selected character area so that the user can recognize the selected character. If multiple character areas are selected, the color of each character area may be different. The character area in the preview and the file name string may be shown in the same color or with the same shading so that the user can recognize correspondence between the character area and the file name string.

In the present embodiment, the correspondence between the selected character area in the preview and the file name display area is made easier to recognize by using the same shaded frame. The position of the preview display may be changed or a zoom factor may be changed so that the selected character area is centered. If a plurality of character areas exists, the preview display position may be calculated so that character areas corresponding to a predetermined number of areas are displayed. If there are a plurality of character areas including the character string used for the file name, the display position and the zoom factor are adjusted to display the preview so that the middle position between the uppermost character area and the lowermost character area corresponds to the center of the preview area in the image of the scanned document. If the user selects a character area as a character string to be used for the file name, underlines, borders, or colors are added to the character area and the character string is added to the file name. If the user deselects the character area, underlines, borders, or colors added to the character area are deleted, and the character string added to the file name is deleted. In the above example, if the user has not selected a character area as the string to use for the file name, the underlines, borders, and/or colors are not displayed in the preview. As another example, underlines, borders, or colors may be used to display the selectable character area to indicate to the user the character area that the user may select as the string to be used for the file name. The indication may be displayed or hidden using on-screen UI, gesture functions, and the like. The user can move the preview area of the image of the scanned document by swiping.

A file name deleting button 613 deletes the character corresponding to the character area added at the end of the file name.

The image displayed in the preview area can be zoomed in by pressing a preview zooming-in button 614. The image displayed in the preview area can be zoomed out by pressing a preview zooming out button 615. If the image displayed in the preview area is zoomed in or out, a center position of the zoomed-in or zoomed-out image displayed in the preview area is adjusted to be same as a center position of the image in the preview area before zooming in or zooming out. An initialization button 616 initializes the zoom factor and the display position if the zoom factor has been changed by pressing the preview zooming-in button 614 or the preview zooming-out button 615 or the display position has been changed by moving or swiping the display position of the preview image.

An OK button 617 closes the file name setting screen. Then, by pressing the transmit button 602, the set file name is transmitted to the MFP cooperation service 120, and the learning process (steps S518 to S519) is executed. At this timing, similar form redetermination processing, which will be explained later, is also performed. If the transmission is completed, the scanned form list screen 600 is displayed on the screen. If the file name setting screen is displayed by selecting a learned form, the file name set based on the learning result and the character area used for the file name are displayed on the screen. It is possible to confirm which character area is used to set file name based on the learning result.

(Image Analysis Processing)

FIG. 7 illustrates a flowchart showing details of image analysis processing performed by the image processing unit 432 in the present system. This flowchart corresponds to steps S507 to S510 in FIG. 5.

First, in step S701, the character area of the input image is analyzed to obtain a character area group in the form. In step S702, the similar form determination is performed. Because these steps have been described in FIG. 5, detailed explanations are omitted. In step S703, it is determined whether there is a similar form. If a similar form is found (Yes in step S703), the process proceeds to step S704. On the other hand, if a similar form is not found (No in step S703), the process proceeds to step S708. In step S704, the character area of the target form corresponding to the character area registered in the found similar form is obtained. In step S705, character recognition processing (OCR) is performed on the corresponding character area obtained in step S704 to extract a character string. By the above processing, the file name that the user seems to desire in the target form can be presented based on the file name setting rule of the similar form.

Then, in step S706, the analysis result is added to the storage area of the learned form. Finally, this flowchart is terminated by notifying the request control unit 431 as a “learned form” in step S707.

On the other hand, if a similar form is not found in step S703, in step S708, the character recognition processing is performed on the entire character area of the form to extract character strings. Here, the character recognition processing is performed for the entire character area because it is determined that there is no similar form and the area that is supposed to be used for setting the file name is unknown. Then, in step S709, the analysis result is added to the storage area of the unlearned form. Finally, this flowchart is terminated by notifying the request control unit 431 as an “unlearned form” in step S710.

<Data Structure of the Image Analysis Result>

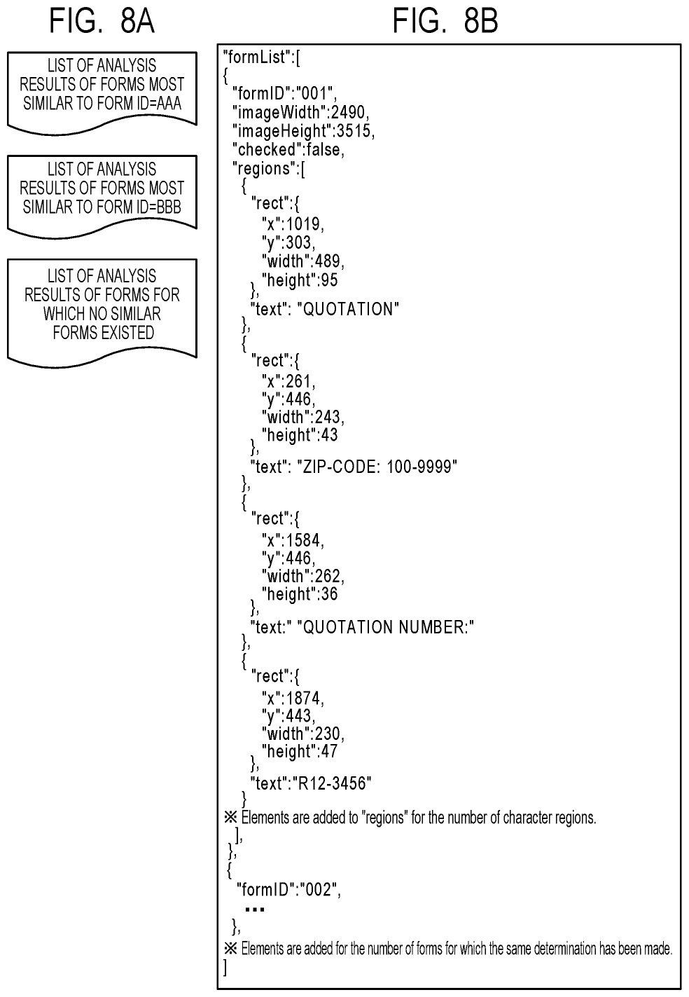

FIGS. 8A and 8B illustrate an example of the data structure stored by the analysis result storage processing performed by the image processing unit in the present system. This data is stored in step S706 or step S709 of FIG. 7.

FIG. 8A illustrates an example of an overview of the data structure of the analysis results. Here, three storage areas exist and are classified based on results of the similar form determination processing in step S509. Specifically, if it is determined that a similar form does not exist, a group of forms determined to have no similar form is stored in one storage area. On the other hand, if it is determined that a similar form exists, a group of forms determined to have a similar form is stored in another storage area. In other words, the group of forms determined to have no similar form and the group of forms determined to have a similar form are stored in different storage areas.

FIG. 8B illustrates an example of the details of the data structure of the analysis results. The analysis results include the character area information analyzed in step S704 of FIG. 7 and the character string information extracted in steps S705 or S708. A “formList” on the root represents a list of forms, and the analysis results for the plurality of forms are stored as an array in each of the areas described in FIG. 8A. Each form has “formID,” “imageWidth,” “imageHeight,” “checked”, and “regions”. The “formID” is an identifier that is unique in this system and is attached to forms. The “imageWidth” indicates the number of pixels in the X (horizontal) direction of the analyzed image. The “imageHeight” indicates the number of pixels in the Y (vertical) direction of the analyzed image. The “checked” indicates that the form has been verified by the user. The “regions” includes the coordinate information of character areas analyzed based on the analyzed image and an array of character information. The information in “regions” is described below. A “rect” indicates the coordinates of one extracted character area. A “x” is the upper left X coordinate of the area, a “y” is the upper left Y coordinate of the area, a “width” is the number of pixels in the X direction of the area, and a “height” is the number of pixels in the Y direction of the area. A “text” indicates the extracted character string as a result of OCR of the character area of “rect” for character recognition. The information of the “rect” and the “text” is included for the total number of character areas in the analyzed scanned image.

<Screen of the Automatic Destination Setting>

FIG. 9 illustrates the setting screen. If the setting button 618 of FIG. 6A is pressed, the setting screen 900 of FIG. 9 is displayed to automatically set whether to transmit the scanned document image with a file name based on the learning result without manual transmission using the screen of FIG. 6A. An automatic transmission setting 901 can be enabled or disabled by selecting a checkbox 902. The user name and the group name are input into a text box 904 for setting target users/groups 903 of the automatic transmitting setting and an add button 905 is pressed to add the user name and the group name to the list. The added user group can be deleted by pressing a delete button 906. If the checkbox for the automatic transmission setting is checked and the user group is not set, it may also be set that the automatic transmission is applied to all users. After the setting is completed, the setting is stored by pressing a save button 907. If a back button 908 is pressed after the setting is completed, the screen in FIG. 6A is displayed on the screen.

(Automatic Transmission Processing)

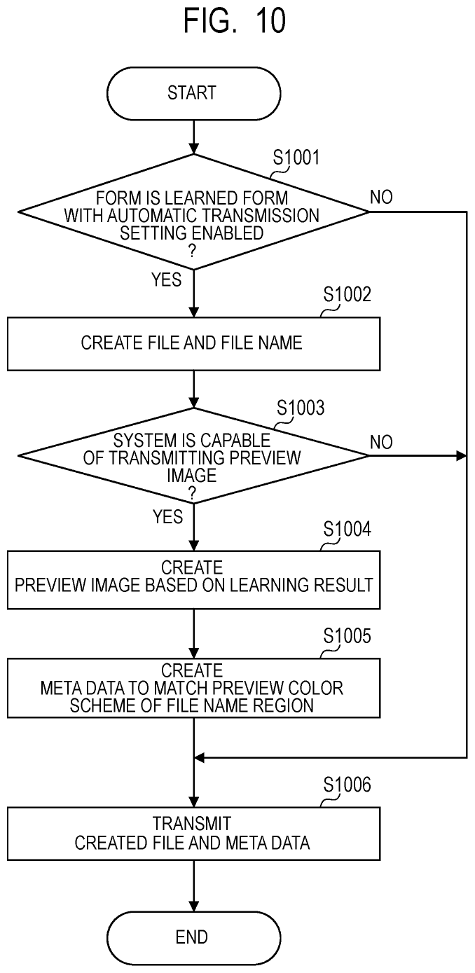

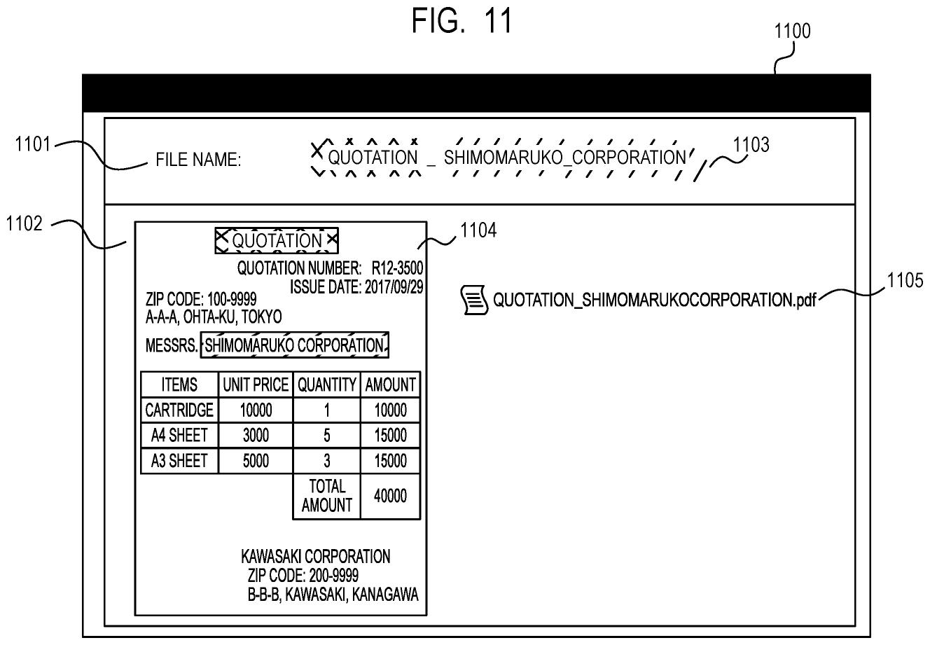

Next, the automatic transmission processing of steps S523 to S526 in FIG. 5 will be described in detail using FIG. 10 and FIG. 11. This processing is performed by the request control unit 431 or the image processing unit 432 of the MFP cooperation service 120.

In step S1001, the request control unit 431 confirms whether or not the automatic transmission setting is enabled. If the automatic transmission setting is enabled, the request control unit 431 confirms whether or not the learned form exists. If the learned form exists (Yes in step S1001), the process proceeds to step S1002. On the other hand, if the learned form does not exist (No in step S1001), the process proceeds to step S1006.

In step S1002, the image processing unit 432 obtains information on the file format to be transmitted to the cloud storage 130 from the scan settings registered in the MFP cooperation service 120 and generates a file from the scanned document image based on the settings. Further, metadata information such as the file name to be set in the file of the scanned document image is generated.

In step S1003, the MFP cooperation service 120 confirms whether or not the destination cloud storage service is a system capable of transmitting preview images together with the scanned document image. Here, the MFP cooperation service 120 further confirms, for example, whether another image can be transmitted in addition to the scanned document image or whether another image can be transmitted as a preview image of the scanned document image. If another image can be transmitted (Yes in step S1003), the process proceeds to step S1004. Otherwise (No in step S1003), the process proceeds to step S1006.

In step S1004, the image processing unit 432 generates the preview image based on the learning result. Specifically, as shown in FIG. 6B, the image processing unit 432 generates the preview image together with character decorations such as coloring and shading of the selected character area. In addition, character decorations such as different colors and different shading can be applied to each character area so that the user can recognize the differences in character areas.

In step S1005, the image processing unit 432 generates metadata using the color and shaded character decoration used for the character area of the preview image generated in step S1004. Specifically, the metadata of the file name is generated so that the color and shading used for each character area of “Quotation” and “Shimomaruko Corporation” are reflected in the character string of the file name area 611 as shown in FIG. 6B. The metadata will be described in XML, JSON, and other formats that can reflect text decorations such as coloring and shading according to the corresponding cloud storage service.

In step S1006, the request control unit 431 transmits the scanned document image file generated in step S1002, the preview image generated in step S1004, and metadata reflecting information such as coloring and shading of the file name generated in step S1005 to the cloud storage 130. If the preview image and metadata generated in steps S1004 and S1005 do not exist, only the scanned document image file and the assigned file name are transmitted as in the case of the manual transmission.

<The Screen Provided by the Cloud Storage Service>

FIG. 11 will be used for describing the screen provided by the cloud storage service. The provided screen is displayed on the client PC 111. FIG. 11 illustrates a screen of the cloud storage showing the results after transmitting to the cloud storage service. Details are described below based on the results of scanning one form.

A display screen 1100 is an example showing a cloud storage service in which a metadata display area 1101 and a file area 1102 capable of preview display exist. A metadata display area is an area for displaying, for example, text messages and file properties. The MFP cooperation service 120 generates a preview image 1104 in which the areas of “Quotation” and “Shimomaruko Corporation” used for the file names are colored and/or shaded and transmits the preview image 1104 together with a scanned document image file 1105. At that time, just as the preview image is colored and shaded, metadata is generated with coloring and shading the corresponding character string in the file name of “Quoteation_Shimomaruko corporation”. The MFP cooperation service 120 transmits the preview image with the metadata to the cloud storage service.

As a result, a file name 1103 reflected with coloring and shading is displayed in the metadata display area 1101. By confirming the file name 1103 in the metadata display area and the preview image 1104 in the file area, it is possible for a user to confirm which character area of the form has been used for the file name without opening the registered scanned image file and looking for the form used for the file name. In the case of a cloud service that does not allow character decoration such as coloring and shading in the metadata display area, an image with the same display as the file name 1103 may be generated and transmitted together with the preview image 1104 and the scanned document image file 1105. In the case of a cloud service that can directly color and shade the file name of the scanned document image file 1105, the coloring and shading may be directly reflected in the file name of the scanned document image file 1105 instead of the metadata display area 1101. In the present embodiment, preview images and metadata based on the learning result are generated and transmitted only by the automatic transmission, but the preview images and metadata based on the learning result can be generated and transmitted by the manual transmission.

According to the present disclosure, the character area of the character string used for the file name of the image of the scanned document can be easily confirmed from the preview image.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-185482, filed Nov. 15, 2021, which is hereby incorporated by reference herein in its entirety.

What is claimed is:

1. An information processing apparatus comprising:
one or more memories; and
one or more processors in communication with the one or more memories, wherein the one or more processors are configured to:
generate data including information of one or more character strings recognized from a scanned document image, wherein the one or more character strings correspond respectively to one or more character areas detected from the scanned document image;
generate a preview image with a character decoration to the one or more character areas of the scanned document image; and
transmit the preview image, the data, and the file including the scanned document image together,
wherein a same character decoration as each of the one or more character areas on the preview image is applied for a different one of the one or more character strings included in the data.

2. The information processing apparatus according to claim 1, wherein the character decoration is shading and/or coloring.

3. The information processing apparatus according to claim 1, wherein the information of each character included in the data corresponds to a filename of the scanned document image.

4. The information processing apparatus according to claim 1, wherein a file format of the data is a XML format or a JSON format.

5. The information processing apparatus according to claim 1, wherein a file format of the data is an image data format.

6. A method of controlling an information processing apparatus comprising:
generating data including information of one or more character strings recognized from a scanned document image, wherein the one or more character strings correspond respectively to one or more character areas detected from the scanned document image;
generating a preview image with a character decoration to the one or more character areas of the scanned document; and
transmitting the preview image, the data, and the file including the scanned document together,
wherein a same character decoration as each of the one or more character areas on the preview image is applied for a different one of the one or more character strings included in the data.

7. A non-transitory computer-readable storage medium storing program to cause a computer to perform a method of controlling an information processing apparatus comprising:
generating data including information of one or more character strings recognized from a scanned document image, wherein the one or more character strings correspond respectively to one or more character areas detected from the scanned document image;
generating a preview image with a character decoration to the one or more character areas of the scanned document; and
transmitting the preview image, the data, and the file including the scanned document together,
wherein a same character decoration as each of the one or more character areas on the preview image is applied for a different one of the one or more character strings included in the data.
